(19) United States
(12) Patent Application Publication
(10) Pub. No.: US 2009/0007742 A1
(43) Pub. Date: Jan. 8, 2009

(54) SLIDING MITER SAW

(75) Inventors: Fangjie Nie, Nanjing (CN); Chaoxu He, Nanjing (CN)

Correspondence Address: GREENBERG TRAURIG, LLP, 77 WEST WACKER DRIVE, SUITE 2500, CHICAGO, IL, 60601-1732, US

(73) Assignee: CHERVON LIMITED, Kwai Chung, NT. (HK)

(21) Appl. No.: 12/142,990

(22) Filed: Jun. 20, 2008

(30) Foreign Application Priority Data
Jul. 4, 2007 (CN) 200720038489.7

(51) Int. Cl. B26D 1/14

(52) U.S. Cl. 83/471.3

(57) ABSTRACT

A sliding miter saw having a base for supporting a workpiece, a rotatable table mounted on the base, a transmission frame on one side of the table, a motor disposed on one end of the transmission frame, and a blade driven by the motor. Two rows of rollers are disposed on a bottom of the table and a sliding block adapted to cooperate with the two rows of rollers is disposed between the two rows of rollers. One end of the sliding block is hinged to the transmission frame.

### BACKGROUND

The following generally relates to cutting saws and, more particularly, relates to a sliding miter saw.

An electric miter saw is a common-used cutting tool and generally includes a rotatable table mounted on a base for supporting a workpiece, a supporting frame hinged on one end of the table, and a circular saw blade driven by a motor mounted on the supporting frame. Before a cutting operation is started, the rotation angle of the table relative to the base should be predetermined. Then when the blade driven by the motor is pivoted downwardly with the supporting frame, a workpiece supported on the base will be cut off with the predetermined angle. Therefore, a largest cutting width is defined by a diameter of the blade.

In order to increase the largest cutting width with the same size of blade, U.S. Pat. No. 5,054,352 and U.S. Pat. No. 5,421,228, incorporated herein by reference in their entirety, both disclose a sliding miter saw comprising an upper or lower moving pair which is disposed between the table and the supporting frame and includes a sliding shaft that cooperates with a shaft sleeve. Therefore, the blade not only is allowed to pivot with the supporting frame up and down relative to the workpiece, but is also allowed to move forwardly and backwardly relative to the workpiece so that a cutting width can be achieved according to a desire requirement.

Yet further, Chinese Pat. No. 021385793, incorporated herein by reference in its entirety, discloses a sliding miter saw which includes a base, a motor, a saw blade, a cutting head frame, and a sliding block. A guiding slot is provided in the radial direction of the table and the sliding block is slideably inserted into the guiding slot. The rear end of the sliding block is connected to the lower part of a supporting member, and the rear end of the cutting head frame is connected to the upper part of the supporting member. The rigidity of the moving pair comprised of the sliding block and the guiding slot is better than that of the moving pair comprised of a sliding shaft and a shaft sleeve and also provides for more space savings.

While these known miter saws do perform as expected, a need remains for an improved sliding miter saw which will be described hereinafter.

### SUMMARY

The following describes an improved sliding miter saw and, more particularly, a sliding miter saw having a fit clearance that is adjustable. To this end, the sliding miter saw comprises a base for supporting a workpiece, a rotatable table mounted on the base, a transmission frame disposed on one side of the table, a motor disposed on one end of the transmission frame, and a blade driven by the motor. In addition, two rows of rollers are mounted onto a bottom of the table and a sliding block cooperating with the rollers is disposed between the two rows of rollers where one end of the sliding block is hinged to the transmission frame. Yet further, the center axis of at least one row of rollers may be mounted on the bottom of the table through an adjustable position member. Thus, by this arrangement of elements, the fit clearance between the rollers and the sliding block may be adjusted to a desire clearance which will allow for a decrease in the accuracy requirement of manufacture. Similarly, once any wearing takes place, the fit clearance may be adjusted to ensure accuracy and quality of a cutting operation.

Abetter appreciation of the objects, advantages, features, properties, and relationships of the sliding miter saw disclosed hereinafter will be obtained from the following detailed description and accompanying drawings which set forth illustrative embodiments which are indicative of the various ways in which the principles described hereinafter may be employed.

### BRIEF DESCRIPTION OF THE DRAWINGS

For use in better understanding the subject sliding miter saw reference may be had to the following drawings in which:

FIG. 1 is a perspective view of an exemplary embodiment of a sliding miter saw constructed in accordance with the described invention;

FIG. 2 is a bottom view of the sliding miter saw shown in FIG. 1 without a base; and

FIG. 3 is an enlarged view of a roller adjustment mechanism of the sliding miter saw shown in FIG. 1.

### DETAILED DESCRIPTION

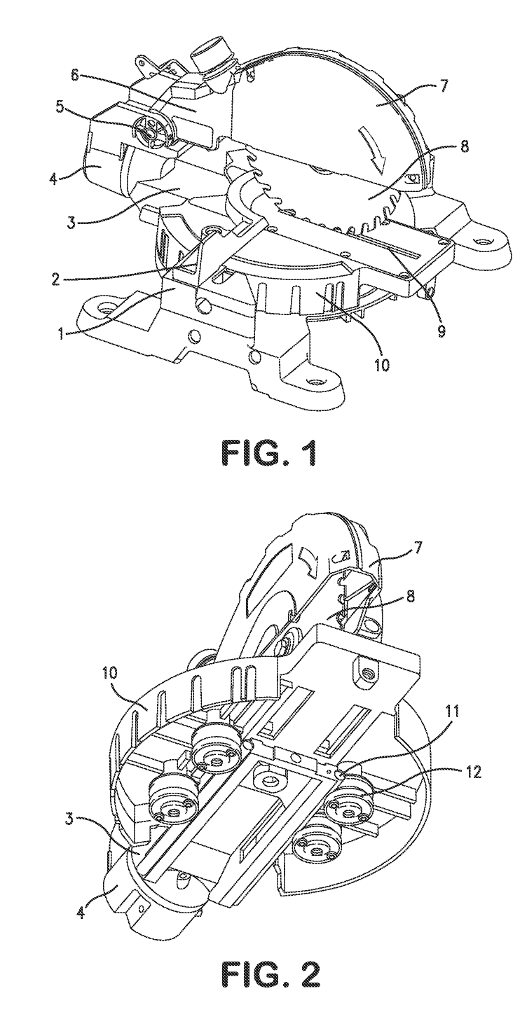

Referring to FIG. 1, a sliding miter of a first embodiment according to the present invention is disclosed. The sliding miter saw comprises a base 1 and a fence 2 for supporting and restraining a workpiece mounted on the upper surface of the base 1. A rotatable and lockable table 10 is mounted on a center hollow space of the base 1 for adjusting a miter cutting angle in a left direction or right direction. Four rollers 12 divided into two rows are mounted on a bottom of the table 10 as shown in FIG. 2. A sliding block 3 is disposed between the two rows of rollers. A middle portion of the table 10 protrudes forwardly and a cover plate 9 having a blade receiving slot is fixed on an upper surface of the table 10. A lower part of the table provides a space for receiving the sliding block 3 and permits the sliding block 3 to move therein.

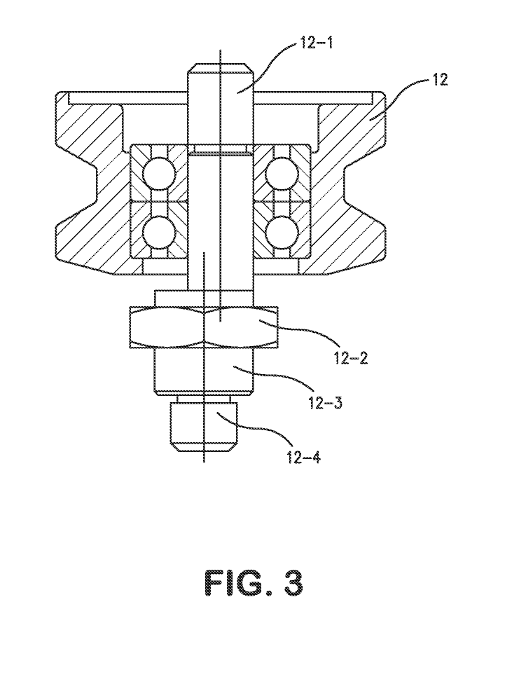

Referring to FIG. 3, each roller 12 has a cylindrical outer surface comprising a middle portion with a groove formed thereon. The groove has an arc-shaped transect. Each of the two sides of the sliding block 3 is arranged to accept a cylindrical sliding rod 11 and a diameter of the rod is designed to match a size provided to the roller grooves. When the assembly process is finished, the two sliding rods 11 are disposed in the corresponding grooves respectively. Therefore, the sliding block 3 can be operated to slide forwardly and backwardly relative to the table 10 while the rollers 12 rotate. The longitudinal and lateral degrees of freedom of the sliding block 3 are restrained through the cooperation of the grooves and the cylindrical sliding rods.

Referring back to FIG. 1, a pivot joint 4 is mounted on a rear end of the sliding block 3 through a lockable rotary pair. An upper end of the pivot joint 4 is hinged with one end of a transmission frame 6 through a pivot shaft 5. A motor and a blade 8 driven by the motor are mounted on the other end of the transmission frame 6. A blade guard 7 is also fixed on the other end of the frame 6. During a cutting operation, the transmission frame 6 is operated to rotate around the pivot shaft 5 in such a manner that a height of the rotating blade 8 relative to a workpiece placed on the base 1 is adjustable. If the workpiece is relatively larger, the blade 8 together with the sliding block 3 can be pushed or pulled to move relative to the base when the blade 8 approaches its lower limit position so as to enlarge the available cutting width. The pivot joint 4 can be pivoted relative to the sliding block 3 to change a pivot cutting angle if necessary.

Referring to FIG. 2, center shafts of the rollers in the left row are directly fixed on the bottom of the table. Referring to FIG. 3, a lower end of a center shaft 12-1 of one of the rollers in the right row and an eccentric shaft 12-3 are formed as a whole body. The eccentric shaft 12-3 has a fastening nut 12-2 connected thereon and a section of screw threads is formed on a bottom end of the eccentric shaft 12-3. During the assembly process, the section of screw threads of the eccentric shaft 12-3 is screwed into the bottom of the table 10. An offset position of the center shaft 12-1 relative to the eccentric shaft 12-3 can be adjusted via rotating of an inner hexagon tenon on an upper end of the center axis 12-1 in such a manner that a distance between a roller in the right row and a corresponding roller in the left row can be changed and a fit clearance between the center shaft 12-1 and the sliding block 3 can also be adjusted. When the assembly process is finished, the eccentric shaft should be locked by the fastening nut 12-2 or other means. To utilize such a structure, accuracy requirements of manufacture can be decreased and the wear can be compensated by an adjustment to recover the accuracy to ensure cutting quality.

The above description referring to the drawings is only intended to describe one preferred embodiment of the present invention and is not intended to limit a protection scope of the present invention. Rather, it will be understood by those of skill in the art that alternatives may be provided without departing from the spirit of the present invention. For example, the arc-transection groove on the cylindrical outer surface of the roller can alternatively be shaped as a groove having V-shaped transection or other shapes. Similarly, the sliding rod is not certainly required to match the groove ideally, but can be disposed just in the groove. Yet further, an adjustable position member can be constructed with a screw-nut pair besides the eccentric shaft structure. Thus, it is to be understood that additional embodiments of the present invention should be considered to be covered by the following claims.

What is claimed is:

1. A sliding miter saw, comprising:
a base for supporting a workpiece;
a rotatable table disposed on the base;
a transmission frame disposed on one side of the table;
a motor disposed on one end of the transmission frame;
a blade connected with and driven by the motor;
two rows of rollers disposed on a bottom of the table; and
a sliding block cooperating with the two rows of rollers and disposed therebetween wherein one end of the sliding block is hinged to the transmission frame.

2. The sliding miter saw of claim 1, wherein center shafts of at least one row of rollers is mounted on the bottom of the table through an adjustable position member.

3. The sliding miter saw of claim 2, wherein lower ends of the center shafts of the at least one row of roller are each formed with an eccentric shaft and a section of screw threads formed on the lower end of the eccentric shaft is screwed into the bottom of the table.

4. The sliding miter saw of claim 2, wherein a groove is formed in a middle portion of a cylindrical outer surface of each roller, a sliding rod is fixed on respective, opposed sides of the sliding block, and each sliding rod is slideable in the groove formed in the middle portion of each roller in a corresponding row of rollers.

5. The sliding miter saw of claim 4, wherein the groove has an arc-shaped transect, the sliding rod is cylindrical-shaped, and a diameter of the sliding rod matches the groove.

6. The sliding miter saw of claim 5, wherein a middle portion of the table protrudes forwardly, a cover plate including a blade receiving slot is fixed on an upper surface of the table, and a lower part of the table provides a space accommodating the sliding block and permits movement of the sliding block therein.

7. The sliding miter saw of claim 6, wherein a pivot joint is mounted on a rear end of the sliding block through a lockable rotary pair, a front upper end of the pivot joint is hinged with one end of the transmission frame, and a motor and a blade driven by the motor are mounted on the other end of the transmission frame.

8. The sliding miter saw of claim 3, wherein a groove is formed in a middle portion of a cylindrical outer surface of each roller, a sliding rod is fixed on respective, opposed sides of the sliding block, and each sliding rod is slideable in the groove formed in the middle portion of each roller in a corresponding row of rollers.

9. The sliding miter saw of claim 8, wherein the groove has an arc-shaped transect, the sliding rod is cylindrical-shaped, and a diameter of the sliding rod matches the groove.

10. The sliding miter saw of claim 9, wherein a middle portion of the table protrudes forwardly, a cover plate including a blade receiving slot is fixed on an upper surface of the table, and a lower part of the table provides a space accommodating the sliding block and permits movement of the sliding block therein.

11. The sliding miter saw of claim 10, wherein a pivot joint is mounted on a rear end of the sliding block through a lockable rotary pair, a front upper end of the pivot joint is hinged with one end of the transmission frame, and a motor and a blade driven by the motor are mounted on the other end of the transmission frame.
